(19) United States
(12) Patent Application Publication
(10) Pub. No.: US 2017/0259155 A1
(43) Pub. Date: Sep. 14, 2017

(54) Virtual Reality-Based Exercise Device and System

(71) Applicant: Chan Bong PARK, Gyeonggi-do (KR)

(72) Inventor: Chan Bong PARK, Gyeonggi-do (KR)

(21) Appl. No.: 15/452,840

(22) Filed: Mar. 8, 2017

(30) Foreign Application Priority Data
Mar. 9, 2016 (KR) 10-2016-0028428

(51) Int. Cl. A63B 71/06; G06F 3/01; A63B 69/00; A63B 69/18; A63B 24/00; A63B 69/04

(52) U.S. Cl. CPC A63B 71/0669; A63B 24/0087; A63B 71/0622; A63B 69/04; A63B 69/0093; A63B 69/18; A63B 69/0028; A63B 69/0071; A63B 24/0084; G06F 3/014; A63B 2230/04; A63B 2230/30

(57) ABSTRACT

A virtual reality-based exercise device includes a fitness device including a main exercise unit providing a predetermined exercise function to a user, a virtual reality device connected to the fitness device to communicate therewith, and a control unit connected to a server to communicate therewith and controlling the main exercise unit, based on information output from the virtual reality device. The control unit receives score information related to the predetermined exercise function stored in the server and provides the score information to the user through the virtual reality device.

### CROSS-REFERENCE TO RELATED APPLICATION(S)

This application claims benefit of priority to Korean Patent Application No. 10-2016-0028428 filed on Mar. 9, 2016 in the Korean Intellectual Property Office, the disclosure of which is incorporated herein by reference in its entirety.

### BACKGROUND

1. Field

The present disclosure relates to virtual reality-based exercise device and system.

2. Description of Related Art

As interest in health has increased, a variety of different types of fitness equipment have been developed. In addition to treadmills and cycling machines, having been widely popular in the past, ski/board machines, surfing machines, rodeo (bull riding) machines, and the like have been developed and distributed, in addition to equestrian machines, capable of providing riding exercise functions in combination with large screens. Such fitness equipment has an advantage in that it may provide an effective exercise effect to a user in an indoor space, but has a problem, in that a user may easily become fatigued due to a simple repetitive exercise mechanism.

### SUMMARY

An aspect of the present disclosure is to provide an exercise device and system combined with virtual reality. Functions of real-time competition and ranking between users, based on virtual reality, may be provided, and assistive exercise using an assistive exercise device or a game function may be provided, thereby inducing lasting interest in a user and reducing user fatigue.

According to an aspect of the present disclosure, a virtual reality-based exercise device includes a fitness device including a main exercise unit providing a predetermined exercise function to a user and a driving unit driving the main exercise unit, a virtual reality device connected to the fitness device to communicate therewith, and a control unit controlling the driving unit, based on information output from the virtual reality device, while being connected to a server to communicate therewith. The control unit receives score information related to the predetermined exercise function stored in the server and provides the received score information to the user through the virtual reality device.

According to an aspect of the present disclosure, a virtual reality-based exercise system includes first and second fitness devices providing a predetermined exercise function to first and second users, respectively, first and second virtual reality devices connected to the first and second fitness devices to communicate therewith, respectively, and a control unit controlling operations of the first and second fitness devices, based on information respectively output from the first and second virtual reality devices, while being connected to a server to communicate therewith. The control unit outputs score information regarding scores acquired as the first and second users perform the predetermined exercise function, through the first and second virtual reality devices, while the predetermined exercise function is provided.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic block diagram of an exercise device according to an exemplary embodiment in the present disclosure;

FIG. 2 is a schematic block diagram of an exercise system according to an exemplary embodiment in the present disclosure;

FIGS. 3 to 6 are diagrams illustrating appearances of fitness devices according to exemplary embodiments in the present disclosure;

FIGS. 7 and 8 are views illustrating screens provided by a virtual reality device in an exercise device according to an exemplary embodiment in the present disclosure;

FIG. 9 is a flowchart illustrating operations of an exercise device according to an exemplary embodiment in the present disclosure; and

FIG. 10 is a flowchart illustrating operations of an exercise system according to an exemplary embodiment in the present disclosure.

### DETAILED DESCRIPTION

Hereinafter, embodiments of the present disclosure will be described with reference to the accompanying drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and propose only a required configuration herein, but are not limited thereto.

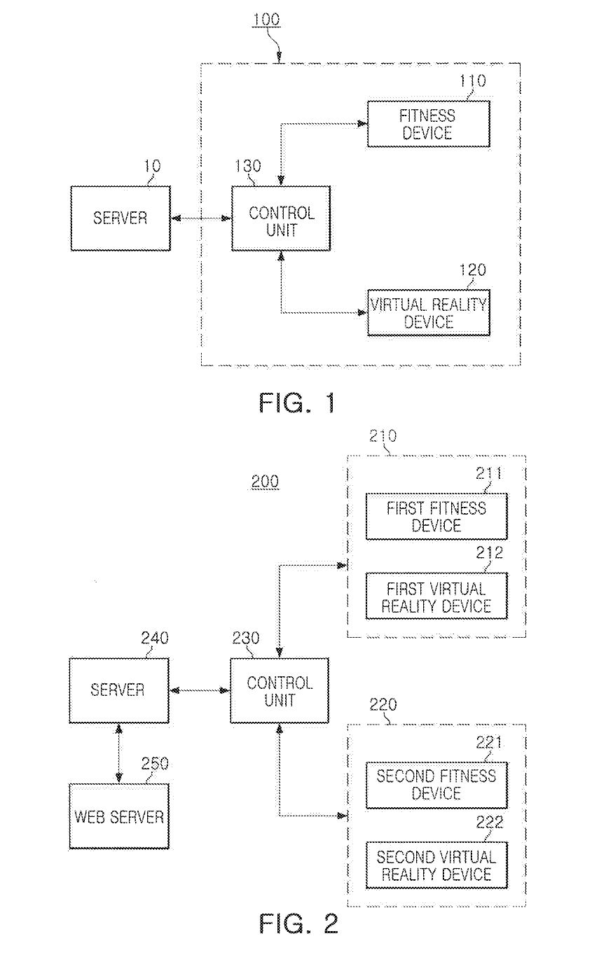

FIG. 1 is a schematic block diagram of an exercise device according to an exemplary embodiment.

Referring to FIG. 1, an exercise device 100 according to an exemplary embodiment may include a fitness device 110, a virtual reality device 120, a control unit 130, and the like. The control unit 130 may be an apparatus provided to control the fitness device 110 and the virtual reality device 120. The control unit 130 may be provided as a control board, a computer device, an integrated circuit (IC) on which a processor, a memory, a communications module, and the like are mounted, or the like. The control unit 130 may be connected to an external server 10 via a communications module to communicate therewith in a wired/wireless manner. The server 10 may be connected to a plurality of the exercise devices 100 to communicate therewith and store and manage information collected by the plurality of exercise devices 100.

The fitness device 110 may include a main exercise unit providing a predetermined exercise function to a user. The exercise function provided to a user by the main exercise unit may be selected from at least one of various exercise functions, such as horse riding, rodeo, skiing, surfing, walking, running, cycling, or the like. In addition, a single main exercise unit may provide a plurality of exercise functions. For example, when the main exercise unit, including a horse model, is included in the fitness device 110, the fitness device 110 may provide horseback riding and rodeo exercise functions together with the horse model. In an exemplary embodiment, an exercise provided by the main exercise unit may be a motion provided so that a user may freely use at least one hand.

Operations of the fitness device 110 may be controlled by the control unit 130. The control unit 130 may change various parameters determining an exercise function provided by the main exercise unit according to a command input by the user. For example, when the main exercise unit provides a walking or running exercise function, the control unit 130 may change a driving speed of the main exercise unit, based on a command input by the user. Further, when the main exercise unit provides a cycling exercise function, the control unit 130 may change a degree of resistance of pedals to provide the cycling exercise function, based on a command input by a user, by which a gear shift effect, like that of a gear change of an actual bicycle, may be obtained.

The exercise device 100 may include the virtual reality device 120. The virtual reality device 120 may be provided in the form of a device that the user may wear. In an exemplary embodiment, the virtual reality device 120 may be a device mounted on a user's head to provide video and audio information to a user.

The control unit 130 may control the virtual reality device 120 to operate in conjunction with the fitness device 110. For example, when the fitness device 110 provides a horse-riding exercise function, the virtual reality device 120 may display backgrounds, such as mountains, plains, valleys, and the like, on which a (virtual) horse may run. On the other hand, for example, when the fitness device 110 provides a rodeo exercise function, the virtual reality device 120 may display a rodeo stadium on a screen. In addition, for example, when the fitness device 110 provides a skiing or snowboarding exercise function, the virtual reality device 120 may provide a more vivid feeling to a user by displaying a snowy mountain or valley or outputting graphics of an actually existing famous ski slope or resort to a screen.

Information provided to a user by the virtual reality device 120 is not limited to the examples as described above, and may be variously modified. For example, when the fitness device 110 provides a cycling exercise function, the virtual reality device 120 may display roads, mountains, valleys, and the like, on which a (virtual) bicycle may be cycled. The control unit 130 may control the fitness device 110 and the virtual reality device 120 to be linked to each other, in such a manner that for example, when a road displayed on the virtual reality device 120 is an uphill road, a resistance of a pedal included in the fitness device 110 may be increased. In a reverse manner, for example, when a road displayed on the virtual reality device 120 is a downhill road, a resistance of a pedal included in the fitness device 110 may be reduced.

The virtual reality device 120 may include at least one or more sensors connected to the body of a user. The sensor may detect biometric information, such as a user's heart rate, pulse rate, blood pressure, and the like. For example, when at least one of the biometric information detected by the sensor is outside of a predetermined reference range, the control unit 130 may transmit a telephone call or a message to a prestored number. For example, when the heart rate of a user using the fitness device 110 is excessively high, the control unit 130 may send a telephone call to a number predesignated by the user or to an emergency number such as 911, or may output predetermined warning sounds or the like, thereby preventing the user from being exposed to a dangerous situation.

The control unit 130 may assign a predetermined score according to a degree of exercise performed by the user while the user uses the fitness device 110, and may display the score using the virtual reality device 120. In addition, the score information received by the user may be stored in the server 10 while the user uses the fitness device 110 or after the user finishes using the fitness device 110. The server 10 may assign a predetermined ranking to users having used the fitness device 110, based on the stored score information, and the users may confirm their own score information and the like by using a web page or a mobile page linked to the server 10, or the like.

The fitness device 110 may further include an auxiliary exercise unit in addition to the main exercise unit as described above. The auxiliary exercise unit may provide a supplementary exercise function or an entertainment function different from the exercise function provided by the main exercise unit. The supplementary exercise function and the entertainment function provided by the auxiliary exercise unit may be a function operating only when linked to the virtual reality device 120.

For example, when the main exercise unit provides a horse-riding exercise function, the auxiliary exercise unit may provide a function different from horse-riding, for example, a shooting game function using an arrow model or a gun model, a polo exercise function, or the like. For example, when the auxiliary exercise unit provides a bow shooting game function, the user may see at least one target displayed on a screen by the virtual reality device 120. Further, the user may perform an arrow shooting operation using an arrow model connected to the control unit 130 to communicate therewith, and the control unit 130 may analyze a position of a bow model, a degree of force applied to the arrow model by the user, and the like, to determine whether or not the arrow model hits a bullseye.

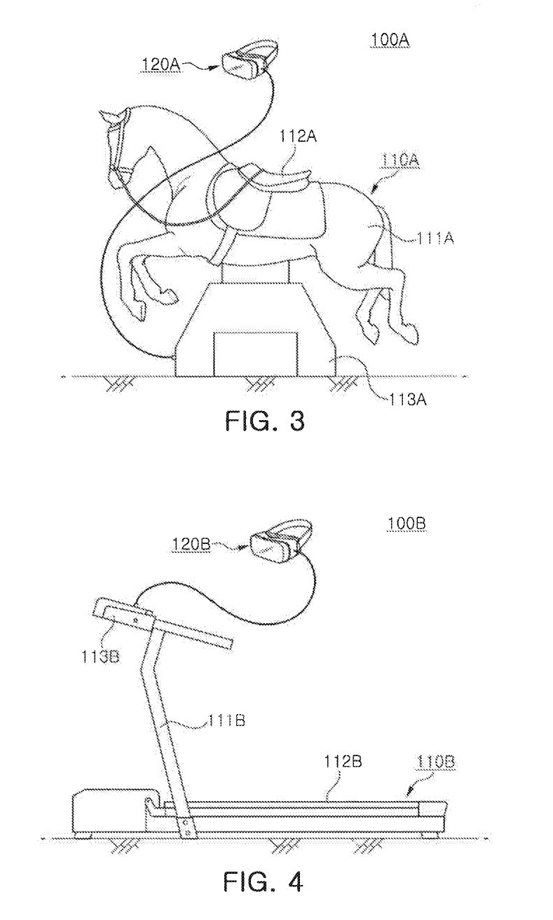

FIG. 2 is a schematic block diagram of an exercise system according to an exemplary embodiment.

Referring to FIG. 2, an exercise system 200 according to an exemplary embodiment may include a first exercise device 210, a second exercise device 220, a control unit 230, a server 240, a web server 250, and the like. Although the server 240 and the web server 250 are illustrated as separate devices, the server 240 and the web server 250 may be implemented as a single device. In addition, although the exemplary embodiment of FIG. 2 illustrates an example in which one control unit 230 controls the plurality of exercise devices 210 and 220, the first and second exercise devices 210 and 220 may also be controlled by separate control units 230. First and second fitness devices 211 and 221 included in the first and second exercise devices 210 and 220, respectively, may be the same kind of fitness devices providing the same exercise function.

The first and second exercise devices 210 and 220 may be used by different first and second users, respectively. While the first and second users use the first and second exercise devices 210 and 220, respectively, the control unit 230 may assign predetermined scores to the first and second users, respectively. The scores may be calculated by the control unit 230 according to a preset process and may be determined according to exercise function types of the first and second fitness devices 211 and 221 performed by the first and second users, respectively. For example, the control unit 230 may assign different respective scores to the first and second users.

The control unit 230 may transmit the scores provided to the first and second users to first and second virtual reality devices 212 and 222 to inform the first and second users of the scores, respectively. For example, the first and second users may check their own acquired scores, and the first and second users may also check a score acquired by a respective opponent, in real time or at predetermined intervals, using the virtual reality devices 212 and 222, while using the first and second fitness devices 211 and 221, respectively. Thus, by inducing competition between the first and second users, a relatively high exercise effect may be induced.

On the other hand, the control unit 230 may transmit the scores acquired by the first and second users, respectively, to the server 240, in real time or at predetermined intervals, or after the use of the exercise devices 210 and 220 by the first and second users is terminated, to thus be stored in the server. The server 240 may store and manage the scores of the respective users, having been received from the control unit 230, and may calculate a rank, a level and the like of a plurality of users, based on score information collected from various places.

The web server 250 may output information regarding the scores of the respective users, stored in the server 240, to a web page, a mobile page, or the like. In addition, the web server 250 may display the scores obtained by the respective users while the first and second users use the exercise devices 210 and 220, on the web page or the mobile page, in real time or at predetermined intervals. Thus, users other than the first and second users may confirm the score information related to scores acquired by the first and second users. The web server 250 may provide a function of betting for goods, for mobile cash, or the like, on the web page or the like, based on the score information obtained by the first and second users.

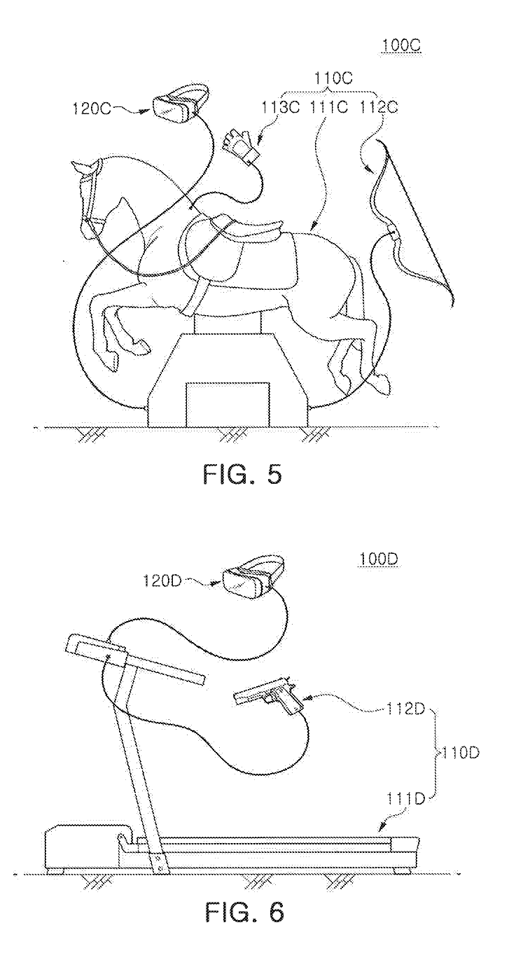

FIGS. 3 to 6 are diagrams illustrating appearances of exercise devices according to exemplary embodiments.

Referring to FIG. 3, an exercise device 100A according to an exemplary embodiment may include a fitness device 110A and a virtual reality device 120A. The fitness device 110A may be a device capable of providing a horse-riding exercise function to a user, and may include a horse model part 111A, a saddle 112A, a driving part 113A, and the like. The driving part 113A may include a driving device operating the horse model part 111A to move up and down, back and forth, or left and right.

The virtual reality device 120A may be provided in the form of goggles that a user may wear on the head, and may provide a virtual reality environment by outputting video and audio information to a user. In the exemplary embodiment illustrated in FIG. 3, the virtual reality environment provided to the user may be a virtual terrain, such as graphics of a mountain, a valley, a desert, a meadow, and the like, on which (virtual) horses may run. In addition, the presence or absence of land features, ground slopes, and the like may be displayed in the virtual reality environment.

In the exemplary embodiment illustrated in FIG. 3, a control unit (not shown) may be accommodated together with the driving part 113A, and the virtual reality device 120A is illustrated as being connected to the driving part 113A, but is not limited thereto. The control unit may control operations of the driving part 113A in conjunction with the virtual reality environment output to the virtual reality device 120A.

Referring to FIG. 4, an exercise device 100B according to an exemplary embodiment may include a fitness device 110B and a virtual reality device 120B. The fitness device 110B may include a frame 111B, a driving part 112B of which a moving speed is changed according to a walking or running speed of a user, and a control panel 113B. The user may directly change an operating speed of the driving part 112B by manipulating the control panel 113B. Alternatively, the control unit may also automatically determine an operating speed of the driving part 112B according to a virtual reality environment provided by the virtual reality device 120B.

The virtual reality device 120B may provide various virtual reality environments to the user. All environments in which a user may walk or run, for example, environments such as underwater, above the clouds, space, and the like, difficult to actually experience, as well as environments such as cities, mountains, valleys, beaches, grasslands, deserts, and the like, may be provided as exercise environments for the user by the virtual reality device 120B. Since the user may have a difficulty to manipulate the control panel 113B while the user wears the virtual reality device 120B, the virtual reality device 120B may include an operation unit able to be manipulated by the user to change an operating speed of the driving part 112B in conjunction with the control panel 113B. For example, the operation unit may be implemented by a device such as a button or a jog shuttle.

Referring to FIG. 5, an exercise device 100C according to an exemplary embodiment may include a fitness device 110C and a virtual reality device 120C. The fitness device 110C may include a main exercise unit 111C providing a user with a horse-riding exercise function, and auxiliary exercise units 112C and 113C providing the user with exercise or game functions other than horse-riding. In the exemplary embodiment illustrated in FIG. 5, although the auxiliary exercise units 112C and 113C may provide an archery function, an auxiliary exercise unit capable of implementing other various functions, such as polo, gun shooting, basketball, and the like may also be provided.

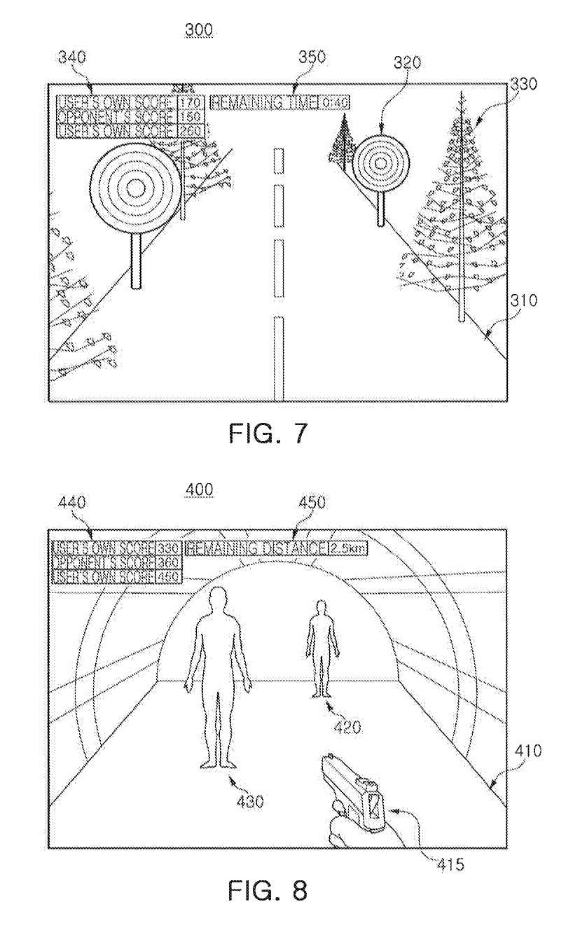

In order to provide the archery function, the auxiliary exercise units 112C and 113C may include a bow 112C and a glove 113C, on which a sensor is respectively attached. The bow 112C may include a sensor sensing force by which the user pulls a bowstring, and the glove 113C may include a sensor sensing a position of the user's hand. For example, when the user is a right-handed person, the user may hold the bow 112C with the left hand and pull the bowstring with the right hand. At this time, the user may calculate a direction in which the user will shoot the bow 112C, from the sensors mounted on the bow 112C and the glove 113C. When the user performs an operation of shooting the bow 112C, a result thereof may be displayed through the virtual reality device 120C. Hereinafter, a description thereof will be provided with reference to FIG. 7.

With reference to FIG. 7, a virtual reality environment 300 provided to a user by the virtual reality device 120C may include a movement path 310 provided to correspond to a moving direction of the fitness device 110C, a target 320 and an obstacle 330, which are the marks to be hit when the user shoots the bow 112C, and the like. As the main exercise unit 111C providing a horse-riding exercise function is driven, the user may feel a sense of running in the virtual reality environment 300 and may receive a score by shooting the bow and hitting the target 320 displayed during running.

The score acquired by the user may be displayed via a scoreboard 340 of the virtual reality environment 300. The virtual reality device 120C may display the score obtained by the user and a score of another user who is exercising together with the user, for example, a score of the opponent. In addition, the scoreboard 340 may display a score of a relatively high rank stored in the server 10 connected to the exercise device 100C. The configuration of the scoreboard 340 may be variously modified. On the other hand, in one region of the virtual reality environment 300, a remaining time 350 during which the user may exercise may be displayed.

The virtual reality device 120C may provide a communications function between the user and an opponent. For example, a function of real-time voice chatting between the user and an opponent, a text chatting function of performing transmission of a text message between the user and the opponent by converting voice recognized by a voice recognition unit into a text, and the like, may be implemented using the voice recognition unit connected to the virtual reality device 120C, or the like. In addition, the virtual reality device 120C may basically have a multimedia output function, and may thus provide a multimedia viewing function in addition to a game function according to a user's selection while the exercise device 100C operates.

Then, referring to FIG. 6, an exercise device 100D according to an exemplary embodiment may include a fitness device 110D and a virtual reality device 120D. The fitness device 110D may include a main exercise unit 111D providing a user with a walking or running exercise function, and an auxiliary exercise unit 112D providing the user with a gun shooting game function. In a manner similar to that described above with reference to FIG. 5, an auxiliary exercise unit capable of providing various functions in addition to the gun shooting function, for example, archery, ball throwing, and flying object catching functions, may also be provided.

In order to implement the gun shooting function, the auxiliary exercise unit 112D may include a gun 112D on which a sensor is mounted. The gun 112D may be a model in which a bullet is not actually fired, and may be connected to the virtual reality device 120D through a control panel of the main exercise unit 111D, or the like. The gun 112D, the virtual reality device 120D, and the main exercise unit 111D may also communicate with each other wirelessly instead of being wired. When the user pulls a trigger of the gun 112D, the virtual reality device 120D may reflect this operation in the virtual reality environment to provide a predetermined game function to the user. Hereinafter, a description thereof will be provided with reference to FIG. 8.

With reference to FIG. 8, a virtual reality environment 400 provided to a user by the virtual reality device 120D may virtually display a weapon 415 corresponding to the gun 112D that the user actually holds in the user's hand, a movement path 410 moving while the user walks or runs using the main exercise unit 111D, and targets 420 and 430 that the user should hit using the virtual weapon 415. The targets 420 and 430 may have various shapes such as a humanoid monster, an animal, a general target, and the like.

For example, when the user triggers the gun 112D, the virtual weapon 415 in the virtual reality environment 400 may be fired. A predetermined sensor may be mounted on the gun 112D, and a control unit (not shown) may determine a position of the gun 112D, a shooting direction of a bullet and the like, from the sensor, to thus determine whether or not the targets 420 and 430 are hit. The virtual reality device 120D may allow the targets 420 and 430 to disappear or may display new targets 420 and 430, according to the hit determined by the control unit in the virtual reality environment 400.

As in the exemplary embodiment illustrated in FIG. 7, a score board 440 may be displayed in the virtual reality environment 400. Thus, users may check not only their own scores but also the score of an opponent enjoying a game together with the respective user, a current first place record stored in the server 10, and the like. The virtual reality device 120D may display a remaining distance 450 that the user should proceed, in the virtual reality environment 400. The remaining distance 450 displayed in the virtual reality environment 400 may be identical to a distance that the user should walk or run on the main exercise unit 110D.

In addition, in a manner similar to the description above with reference to FIG. 7, the virtual reality device 120D may provide a communications function between the user and an opponent, and a multimedia appreciation function for a user. For example, when the user uses the multimedia appreciation function through the virtual reality device 120D, a game function may not be performed according to a multimedia type. For example, when the user wants to appreciate an audio-type multimedia function without images, the multimedia appreciation function may be provided together with a game function.

In the exemplary embodiments described above with reference to FIGS. 5 to 8, the configurations of the fitness devices 110C and 110D and the configurations of the virtual reality environments 300 and 400 may be variously modified. For example, targets and the like may be set to be matched with backgrounds of the virtual reality environments 300 and 400 according to types of auxiliary exercise units. In addition, conditions in which the user uses the exercise devices 100C and 100D may be limited to time, a distance, or the like according to a setting by the user carried out before or during the exercise. Various configurations according to the exemplary embodiments described with reference to FIGS. 5 to 8 may be applied to each other.

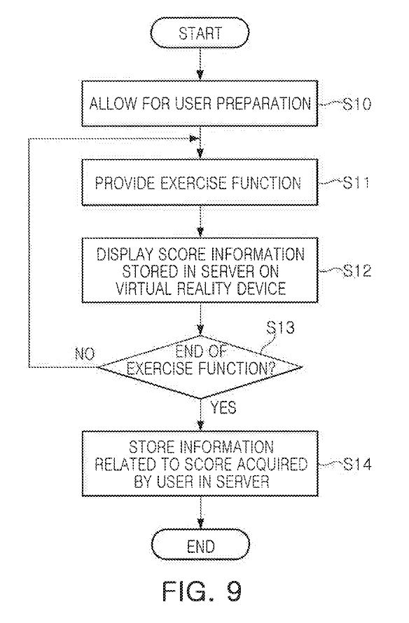

FIG. 9 is a flowchart illustrating operations of an exercise device according to an exemplary embodiment. A description thereof will be provided below with reference to FIGS. 9 and 1.

Referring to FIG. 9, an operation of an exercise device 100 according to an exemplary embodiment may be started by allowing a control unit 130 to prepare to use the exercise device 100 of a user, in S10. In S10, the user may set a reference condition, such as a time, a distance, or the like to perform an exercise function provided by the exercise device 100, and may also select a supplementary exercise function. For example, since one exercise device 100 may provide a plurality of supplementary exercise functions, the user may select one of the plurality of supplementary exercise functions in S10.

When the user's preparation is completed, the exercise device 100 may provide a user with an exercise function in S11. The exercise function may be determined according to a type of a main exercise unit included in a fitness device 110 of the exercise device 100. For example, according to the exemplary embodiments illustrated in FIGS. 3 and 5, the exercise function may be horse riding, and according to the exemplary embodiments illustrated in FIGS. 4 and 6, the exercise function may be a walk or a run. In addition, various exercise functions such as rodeo, skiing, snowboarding, surfing, and the like may be provided by different main exercise units.

While the user performs the exercise function, the user may confirm information related to a score acquired by the user through a virtual reality device 120, in S12. The virtual reality device 120 may also display score information related to other users enjoying the exercise function together with the user, and score information related to other users stored in a server 10, as well as the user's own score information. The user may check score information related to an opponent or score information related to other users stored in the server, by which the user's competition may be induced to thus achieve a relatively high exercise effect.

While the user performs the exercise function, the control unit 130 may confirm whether or not the exercise function ends in S13. For example, when it is confirmed in S13 that the exercise function is continuously executed, the control unit 130 may allow for continuous performance of the operations in S11 and S12. On the other hand, when it is confirmed in S13 that the exercise function has been terminated, the control unit 130 may display information related to a final score acquired by the user on the virtual reality device 120 and may store the score information in the server 10, in S14. The score information stored in the server 10 may be compared to score information related to other users to thus be used in providing ranking, levels, and the like.

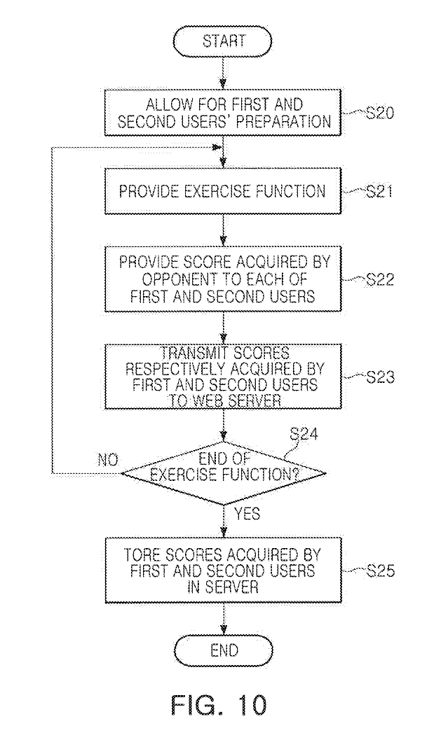

FIG. 10 is a flowchart illustrating operations of an exercise system according to an exemplary embodiment. A description thereof will be provided below with reference to FIGS. 10 and 2.

With reference to FIG. 10, an operation of an exercise system 200 according to an exemplary embodiment may be started by preparing use of exercise devices 210 and 220 of a plurality of users, for example, first and second users, by a control unit 230, in S20. Operations performed in S20 may be similar to the operations in S10 described above with reference to FIG. 9, except that the users and the exercise devices 210 and 220 are a plurality of users and a plurality of devices.

For example, when the user's preparation is completed, the control unit 230 may provide score information to respective first and second users while providing exercise functions in S21 and S22. In 322, score information may be provided through virtual reality devices 212 and 222 of the first and second users, respectively, and the first and second users may receive information related to a score acquired by a respective opponent, as well as information regarding the user's own scores. Thus, an exercise effect may be enhanced by encouraging competition between the first and second users.

On the other hand, the control unit 230 may transmit information related to scores respectively obtained by the first and second users, to a web server 250, in S23. The web server 250 having received the score information from the control unit 230 may display the score information on a web page, a mobile page, or the like. The score information displayed on a web page, a mobile page, or the like may be used as a material to provide a betting function to users other than the first and second users.

While the first and second users perform the exercise function, the control unit 230 may confirm whether the exercise function ends in S24. For example, when it is confirmed in S24 that the exercise function is continuously executed, the control unit 230 may allow for continuous performance of the operations in S21 and S23. On the other hand, when it is determined in S24 that the exercise function has been terminated, the control unit 230 may display information related to final scores acquired by the users on the virtual reality device 212 and 222, and may store the score information in the server 240, in S25. The score information stored in the server 250 may be compared to score information related to other users to thus be used to provide a ranking, a level, and the like or to provide a betting function in a web page, a mobile page, or the like.

As set forth above, in virtual reality-based exercise device and system according to an exemplary embodiment, competition, ranking functions, and the like through exercise among users may be provided using virtual reality technology. In addition, as supplementary exercise or game functions are provided using an auxiliary exercise device, continuous interest may be provided to a user during exercise, and user fatigue may be reduced. Furthermore, various and additional functions may be provided to a user.

While exemplary embodiments have been shown and described above, it will be apparent to those skilled in the art that modifications and variations could be made without departing from the scope of the present disclosure as defined by the appended claims.

What is claimed is:

1. A virtual reality-based exercise device comprising:
a fitness device including a main exercise unit providing a predetermined exercise function to a user;
a virtual reality device connected to the fitness device to communicate therewith; and
a control unit connected to a server to communicate therewith and controlling the main exercise unit, based on information output from the virtual reality device,
wherein the control unit receives score information related to the predetermined exercise function stored in the server and provides the score information to the user through the virtual reality device.

2. The virtual reality-based exercise device of claim 1, wherein the virtual reality device comprises a sensor attached to the body of the user and detecting at least one of a heart rate, a pulse rate, and blood pressure of the user.

3. The virtual reality-based exercise device of claim 2, wherein when information detected by the sensor is determined to be outside of a predetermined reference range, the control unit transmits a telephone call to a prestored number.

4. The virtual reality-based exercise device of claim 1, further comprising an auxiliary exercise unit providing at least one of a supplementary exercise function and an entertainment function to the user.

5. The virtual reality-based exercise device of claim 4, wherein the control unit outputs information corresponding to at least one of the supplementary exercise function and the entertainment function through the virtual reality device, and receives score information related to at least one of the supplementary exercise function and the entertainment function from the server and provides the received score information to the user.

6. The virtual reality-based exercise device of claim 4, wherein the auxiliary exercise unit provides at least one of basketball, polo, archery, gun shooting and ball catching functions to the user.

7. The virtual reality-based exercise device of claim 1, wherein the main exercise unit provides at least one of horse riding, surfing, rodeo, running, walking and skiing functions, to the user.

8. The virtual reality-based exercise device of claim 1, wherein the control unit stores the score information related to the predetermined exercise function performed by the user, in the server.

9. A virtual reality-based exercise system comprising:
first and second fitness devices providing a predetermined exercise function to first and second users, respectively;
first and second virtual reality devices connected to the first and second fitness devices to communicate therewith, respectively; and
a control unit connected to a server to communicate therewith and controlling operations of the first and second fitness devices, based on information respectively output from the first and second virtual reality devices,
wherein the control unit outputs score information regarding scores acquired as the first and second users perform the predetermined exercise function, through the first and second virtual reality devices, while the predetermined exercise function is provided.

10. The virtual reality-based exercise system of claim 9, wherein the control unit outputs the score information related to the predetermined exercise function stored in the server, through the first and second virtual reality devices, while the predetermined exercise function is provided.

11. The virtual reality-based exercise system of claim 9, wherein the control unit stores the score information regarding the scores acquired as the first and second users perform the predetermined exercise function, in the server, while the predetermined exercise function is provided.

12. The virtual reality-based exercise system of claim 11, wherein the control unit displays the score information regarding the scores acquired as the first and second users perform the predetermined exercise function, on a predetermined web page in real time, while the predetermined exercise function is provided.

13. The virtual reality-based exercise system of claim 9, wherein the control unit outputs the same information through the first and second virtual reality devices.

14. The virtual reality-based exercise system of claim 9, wherein the first and second fitness devices respectively provide a supplementary exercise function, different from the predetermined exercise function, to the first and second users.

15. The virtual reality-based exercise system of claim 14, wherein the control unit outputs the score information regarding the scores acquired as the first and second users perform the supplementary exercise function, through the first and second virtual reality devices, while the predetermined exercise function is provided.
